(19) United States
(12) Patent Application Publication
(10) Pub. No.: US 2003/0121483 A1
(43) Pub. Date: Jul. 3, 2003

(54) Cross flow engine cooling system

(76) Inventors: Neil W. Loughlin, Ortonville, MI (US); Rudy W. Sayn, Taylor, MI (US); Timothy R. Zuehlke, Oregon, MI (US)

Correspondence Address: Ralph E. Smith, DaimlerChrysler Intellectual Capital Corporation, CIMS 483-02-19, 800 Chrysler Drive, Auburn Hills, MI, 48326-2757, US

(21) Appl. No.: 10/035,011

(22) Filed: Dec. 27, 2001

(51) Int. Cl. F02F 1/10

(52) U.S. Cl. 123/41.72

(57) ABSTRACT

A cooling system is provided for an engine utilizing a parallel flow configuration such that coolant flows from the outer regions of the engine block into the engine block's inner core. Parallel flow is used to maintain equivalent cylinder temperatures.

### FIELD OF THE INVENTION

The present invention relates generally to an engine cooling system. In particular, the present invention relates to a cross flow engine cooling system wherein coolant moves from the outer regions of the engine block into the engine block's inner core in a parallel flow configuration.

### BACKGROUND OF THE INVENTION

A cooling system for engines is well known in the art. Typical engine cooling systems work by pumping coolant through the engine in an axial flow direction. Specifically, a coolant pump feeds coolant directly into the engine block's coolant jacket. The coolant flows from the front of the block to the back of the block, with the coolant increasing in temperature as it flows from front to back. Then, the coolant flows up into the back of the cylinder head and through to the front of the cylinder head where it flows to an outlet at the top of the engine. Similarly, the flow of the coolant from the back to the front of the cylinder head results in another coolant temperature increase.

This cooling system results in the engine's front cylinders having the coldest bores and hottest combustion chambers, while the rear cylinders have the hottest bores and coldest combustion chambers. This variation in cylinder temperatures can exceed 30 degrees. Further, since each cylinder is cooled differently, piston ring sealing and spark timing is different for each cylinder.

In order to get around this problem, especially in high performance applications, manufacturers have resorted to running exterior coolant lines from the coolant pump to the sides of the engine block to force more coolant flow around the rear cylinders. Additionally, external lines have been used to enhance coolant flow at selected cylinder head hot spots. Hence, engine packaging is increased which in turn increases system cost and chance of failure.

Accordingly, a need exists for a cooling system that minimizes temperature variation between the cylinders without increasing the engine package.

### SUMMARY OF THE INVENTION

The present provides a cooling system for an engine with multiple cylinders. This system employs at least one inlet manifold with multiple coolant passages which are associated with a respective cylinder coolant jacket. The inlet manifold serves to bring coolant into the engine. The coolant from the inlet manifold flows through the coolant passages into the respective cylinder coolant jacket. The coolant entering each of the respective cylinder coolant jackets is generally of the same temperature, hence this coolant system reduces the temperature of the cylinders with little variation between cylinder temperatures.

### BRIEF DESCRIPTION OF THE DRAWINGS

The present invention will become more fully understood from the detailed description and the accompanying drawings, wherein:

FIG. 1 is a three-dimensional perspective view of an internal combustion engine exhibiting coolant flow according to the principles of the present invention;

FIG. 2 of the present invention is a front view of the internal combustion engine shown in FIG. 1;

FIG. 3 is a side view of the engine block shown in FIG. 1;

FIG. 4 is a top view of the deck of a cylinder section of the block of the internal combustion engine according to the principles of the present invention;

FIG. 5 is a side view of the cylinder head of the internal combustion engine of the present invention;

FIG. 6 is a top view of the coolant outlet manifold for the internal combustion engine according to the principles of the present invention; and

FIG. 7 is a cross sectional view along line 7-7 of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

The present invention is generally related to a cooling system for an engine. In this regard, the cooling system will be described in the context of an internal combustion engine with eight cylinders in a ninety degree formation. However, it is to be understood that the principles embodied herein are equally applicable to other types of engines and engines in different formations as well.

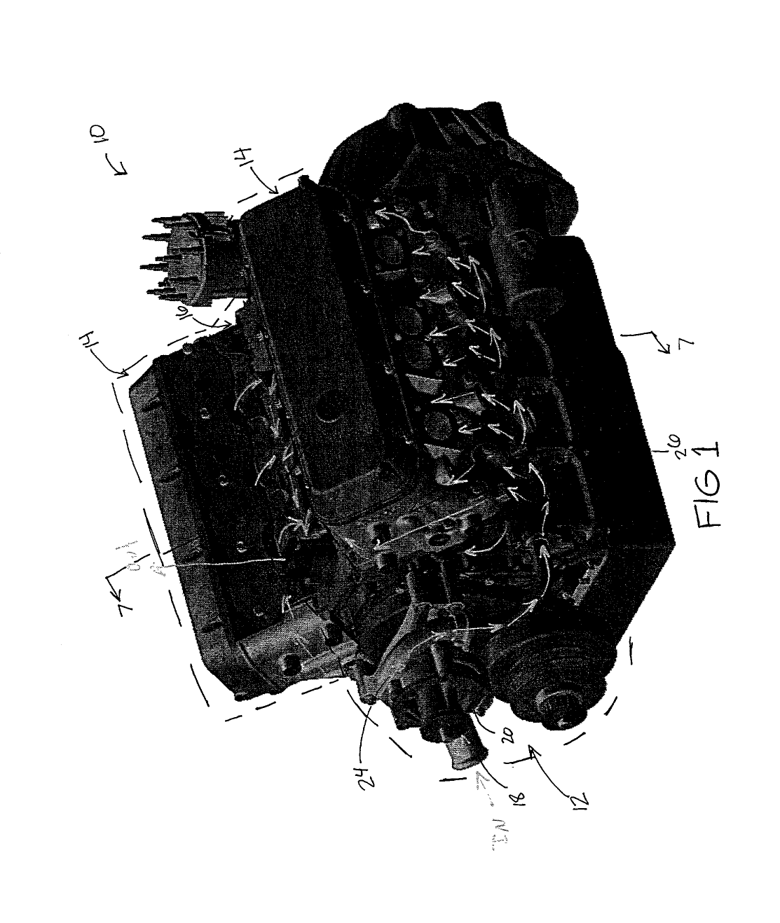

FIG. 1 is a three-dimensional perspective view of an engine 10 including a coolant entry section 12 in fluid communication with a coolant distribution system 14 which is also in fluid communication with a coolant exit system 16. The distribution system 14 and coolant exit system 16 will be discussed with reference to only one side of the engine 10. It is to be understood that the distribution system 14 and exit system 16 are identical on either side of the engine.

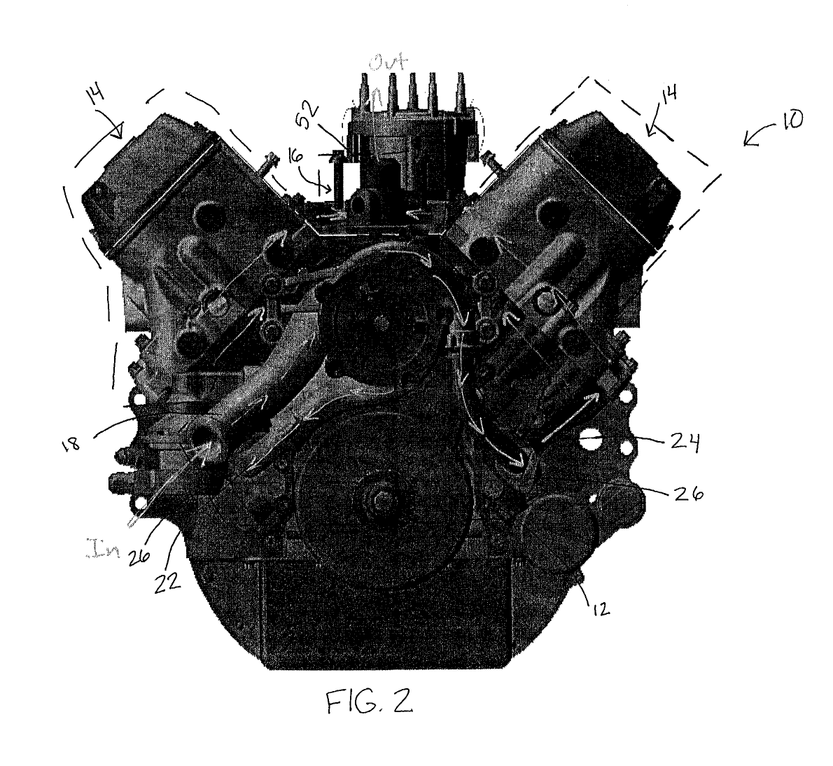

Referring to FIG. 2, the coolant entry section 12 includes an entry port 18 in fluid communication with a pump 20, as shown in the art. The pump 20 is positioned on the front of the engine 10. The pump 20 is in fluid communication with two feeder lines, 22 and 24. Feeder line 22 is located on the right side of the engine 10, and feeder line 24 is on the left side of the block. Both feeder lines 22 and 24 are in fluid communication with the distribution system 14.

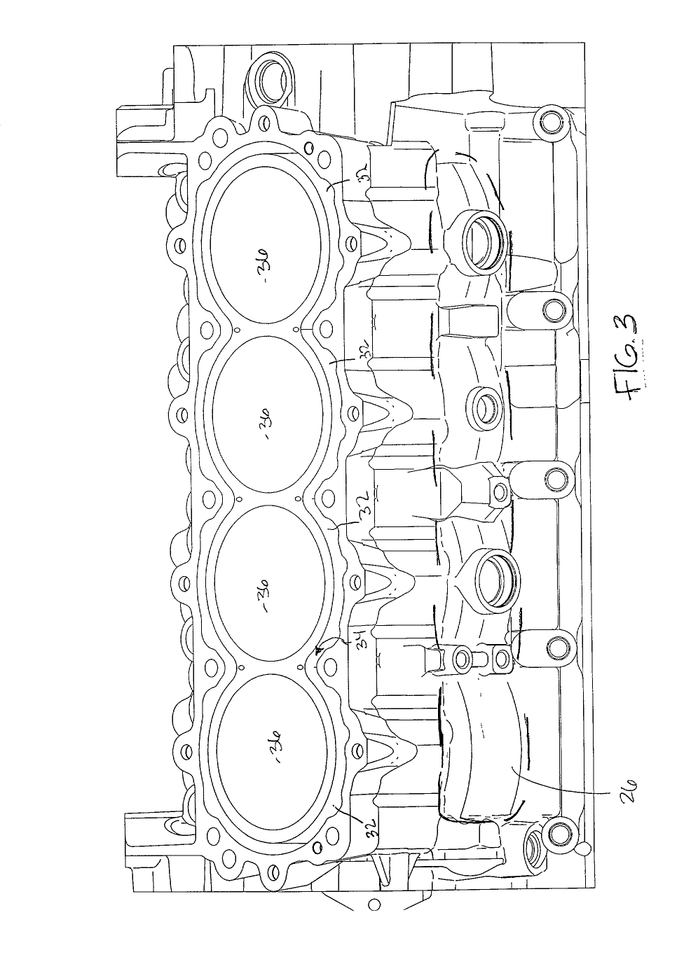

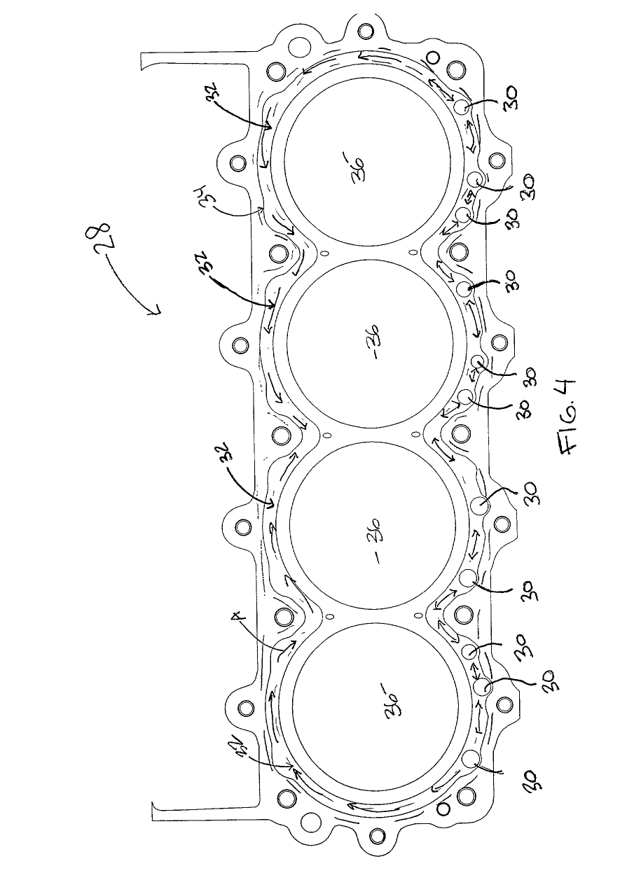

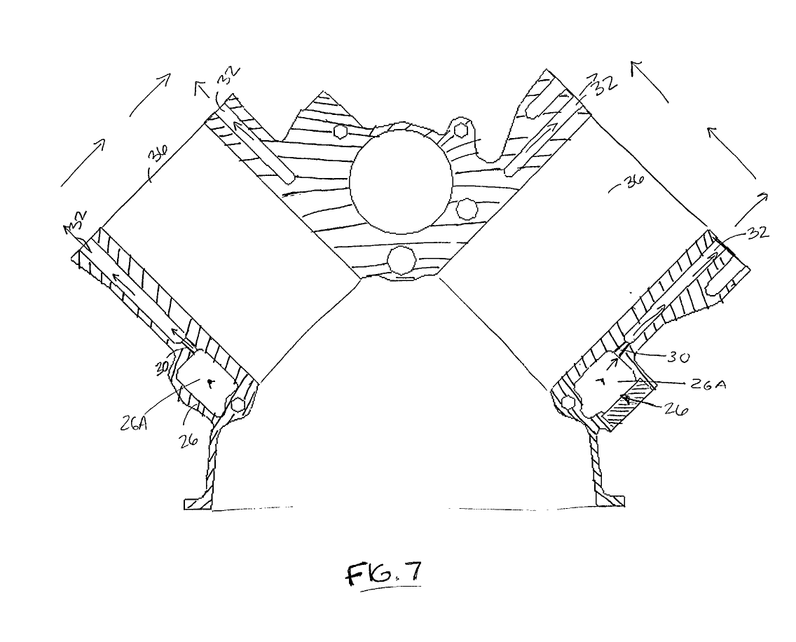

The distribution system 14 has an inlet manifold 26 in fluid communication with the entry section 12. The inlet manifold 26 runs along the side of the engine 10 and defines a manifold chamber 26A that decreases in area from front to back as best shown in FIG. 3. The inlet manifold 26 in FIG. 3 is encircled with dashed lines and is also detailed in FIG. 7. Now referring to FIG. 4, the distribution system 14 further includes a coolant network 28 and a cylinder head 38. This coolant network 28 is in fluid communication with the cylinder head 38.

The coolant network 28 includes multiple coolant passages 30, best shown in FIGS. 4 and 7, which are in fluid communication with the inlet manifold 26. Referring to FIGS. 4 and 7, these coolant passages 30 are also in fluid communication with a respective cylinder coolant jacket 32. The individual cylinder coolant jackets 32 combine to make up a coolant chamber 34. This coolant chamber 34 surrounds the cylinders 36. The cylinders 36 in the engine 10 each share a wall, commonly known as a Siamese configuration, but they could also be in a standard spaced apart pattern, such that the coolant jackets 32 fully encircle the individual cylinders.

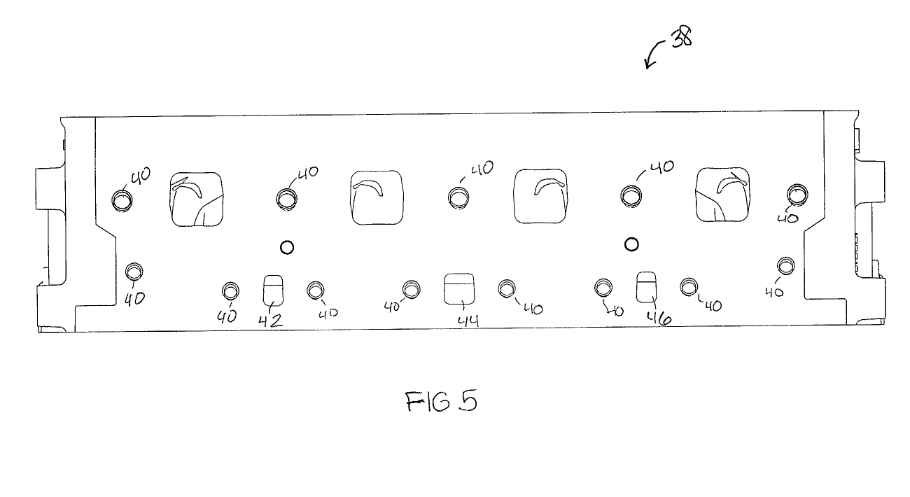

Referring to FIG. 5, a side view of the cylinder head 38 of the distribution system 14 is shown. The cylinder head 38 is in fluid communication with the coolant network 28 and includes bolt holes 40 which receive bolts (not shown) which also engage the bolt holes in the engine 10. Specifically, multiple coolant passages (not shown) in the cylinder head area 38 are in fluid communication with the coolant chamber 34. These coolant passages are also in fluid communication with exit ports 42, 44 and 46 in the side of the cylinder head 38. The exit ports 42, 44, and 46 are aligned in parallel, with central exit port 44 sized such that it is approximately twice the size of exit ports 42 and 46. This ensures uniform coolant flow. The exit ports 42, 44 and 46 are in further fluid communication with the coolant exit system 16.

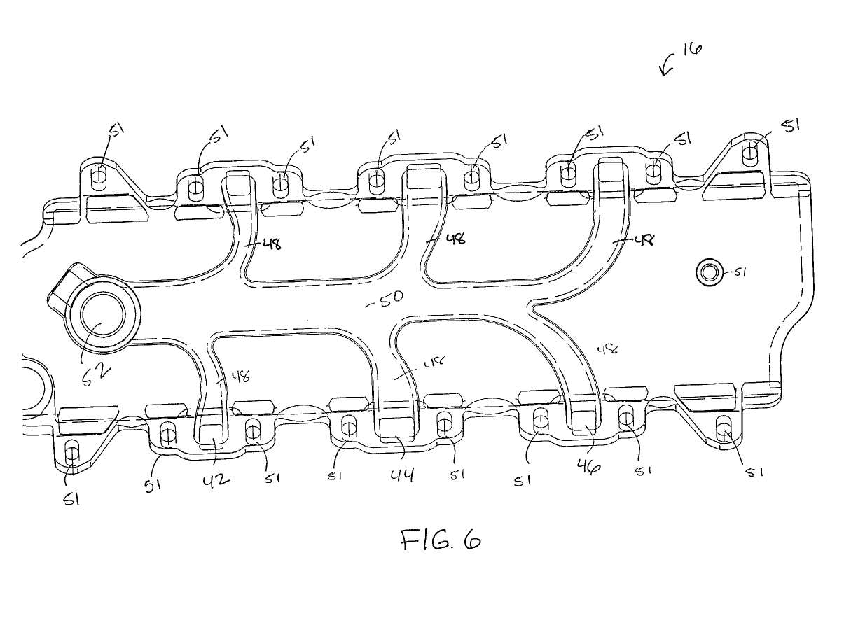

With reference to FIG. 6, coolant exit system 16 includes cylinder outlet passages 48 in fluid communication with distribution system 14. Specifically, the cylinder outlet passages 48 are in fluid communication with exit ports 42, 44 and 46. These cylinder outlet passages are also fluidly coupled to an outlet manifold 50. The outlet manifold 50 is in fluid communication with an outlet 52. Outlet 52 is in fluid communication with a radiator (not shown). The manifold 50 includes bolt holes 51 which receive bolts (not shown) which also engage the bolt holes 40 in the cylinder head 38.

FIG. 7 is a cross-section of the engine 10, taken through the third and fourth cylinders 36. The cylinders 36 have corresponding cylinder coolant jackets 32. The coolant passages 30 fluidly connect the cylinder coolant jackets 32 to the inlet manifold 26. Specifically, the coolant passages 30 fluidly connect the cylinder coolant jackets 32 to the coolant flow area 26A of the inlet manifold 26. In this cross section, the inlet manifold coolant flow area 26A has been slightly reduced to ensure proper flow distribution at the rear of the inlet manifold 26.

During operation of the engine 10, coolant enters the pump 20 through an entry port 18. The pump then forces the coolant into two feeder lines 22 and 24. Following feeder line 24 only, with the understanding that the process is identical for both feeder line 22 and 24, feeder line 24 sends coolant into the inlet manifold 26. From inlet manifold 26, coolant is carried by coolant passages 30 into the respective cylinder coolant jackets 32. The coolant flows from the coolant jackets 32 and around the coolant chamber 34 as illustrated by the arrows A in FIG. 4. The coolant from the coolant chamber 34 is then forced up into the cylinder head 38 through multiple coolant passages. From the cylinder head 38, coolant flows out exit ports 42, 44 and 46 into the respective outlet passages 48. From the outlet passages 48, coolant flows into the outlet manifold 50 where it is forced to exit the system through outlet 52 into the radiator.

The cooling system of the present invention greatly reduces temperature variation between cylinders. Test results have shown variation as low as 12 degrees across the entire engine, hence improving engine performance and durability by reducing the occurrence of hot piston scuffing and detonation as well as improved ring sealing and reduced piston ring tension. In addition, this system allows flow to be precisely targeted to each area of the engine through manipulation of the diameter of the coolant passages. In this embodiment, the inlet manifold 26 is cast in the engine 10, and thus reduces external packaging.

What is claimed is:

1. An engine comprising:
an engine block defining a plurality of cylinders; and
a coolant system including at least one inlet manifold and a plurality of coolant passages, each communicating with said inlet manifold and delivering fluid to a coolant jacket portion of a respective cylinder.

2. The engine of claim 1 wherein said block has a pair of ends and a pair of sides wherein said inlet manifold runs along at least one of said sides of said block.

3. The engine of claim 2 wherein said inlet manifold decreases in cross-sectional area from one of said pair of ends to the other said pair of ends of said engine block.

4. The engine of claim 1 wherein said coolant passages are generally perpendicular to said inlet manifold.

5. The engine of claim 1 wherein said coolant passages have a circular cross-section.

6. The engine of claim 1 wherein said plurality of coolant jackets define a coolant chamber said coolant chamber surrounds said plurality of cylinders.

7. The engine of claim 1 further comprising a cylinder head fastened to said block above said coolant jackets wherein said cylinder head contains a plurality of ports for fluid transfer.

8. The engine of claim 7 wherein said ports are in fluid communication with a coolant outlet manifold.

9. The engine of claim 8 wherein said coolant outlet manifold is in fluid communication with a radiator hose.

10. An engine comprising:
an engine block defining a plurality of cylinders; and
a coolant system including at least one inlet manifold integrally formed with said block and a plurality of coolant passages perpendicular to said inlet manifold, each communicating with said inlet manifold and delivering fluid to a coolant jacket of a respective cylinder.

11. The engine of claim 10 wherein said block has a pair of ends and a pair of sides wherein said inlet manifold runs along at least one of said sides of said block.

12. The engine of claim 11 wherein said inlet manifold decreases in cross-sectional area from one of said pair of ends to the other said pair of ends of said engine block.

13. The engine of claim 10 wherein said coolant passages are generally perpendicular to said inlet manifold.

15. The engine of claim 10 wherein said coolant passages have a circular cross-section.

16. The engine of claim 10 wherein said plurality of coolant jackets define a coolant chamber said coolant chamber surrounds said plurality of cylinders.

17. The engine of claim 10 further comprising a cylinder head mechanically fastened to said block above said coolant jackets wherein said cylinder head contains a plurality of ports for fluid transfer.

18. The engine of claim 17 wherein said ports are in fluid communication with a coolant outlet manifold.

19. The engine of claim 18 wherein said coolant outlet manifold is in fluid communication with a radiator hose.
